(19) United States
(12) Patent Application Publication
(10) Pub. No.: US 2018/0332606 A1
(43) Pub. Date: Nov. 15, 2018

(54) METHOD AND APPARATUS FOR ALLOCATING COMMON SPS RESOURCE ACROSS MULTIPLE CELLS IN WIRELESS COMMUNICATION SYSTEM

(71) Applicant: LG ELECTRONICS INC., Seoul (KR)

(72) Inventors: Youngdae LEE, Seoul (KR); Sunghoon JUNG, Seoul (KR); Sunyoung LEE, Seoul (KR)

(73) Assignee: LG ELECTRONICS INC., Seoul (KR)

(21) Appl. No.: 15/775,948

(22) PCT Filed: Dec. 19, 2016
(86) PCT No.: PCT/KR2016/014861

§ 371 Date: May 14, 2018

Related U.S. Application Data
(60) Provisional application No. 62/269,106, filed on Dec. 18, 2015.

(51) Int. Cl. H04W 72/12; H04W 4/40

(52) U.S. Cl. CPC H04W 72/1289; H04W 4/40

(57) ABSTRACT

A method and apparatus for determining validity of a semi-persistent scheduling (SPS) resource across multiple cells in a wireless communication system is provided. A user equipment (UE) receives a SPS resource configuration including time information related to validity of the SPS resource configuration from a network, and determines whether the SPS resource configuration is valid or not according to the time information.

### TECHNICAL FIELD

The present invention relates to wireless communications, and more particularly, to a method and apparatus for allocating a common semi-persistent scheduling (SPS) resource across multiple cells in a wireless communication system.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

The pace of LTE network deployment is accelerating all over the world, which enables more and more advanced services and Internet applications making use of the inherent benefits of LTE, such as higher data rate, lower latency and enhanced coverage. Widely deployed LTE-based network provides the opportunity for the vehicle industry to realize the concept of ‘connected cars’. By providing a vehicle with an access to the LTE network, a vehicle can be connected to the Internet and other vehicles so that a broad range of existing or new services can be envisaged. Vehicle manufacturers and cellular network operators show strong interests in vehicle wireless communications for proximity safety services as well as commercial applications. LTE-based vehicle-to-everything (V2X) study is urgently desired from market requirement, and the market for vehicle-to-vehicle (V2V) communication in particular is time sensitive. There are many research projects and field tests of connected vehicles in some countries or regions, such as US/Europe/Japan/Korea.

V2X includes a vehicle-to-vehicle (V2V), covering LTE-based communication between vehicles, vehicle-to-pedestrian (V2P), covering LTE-based communication between a vehicle and a device carried by an individual (e.g. handheld terminal carried by a pedestrian, cyclist, driver or passenger), and vehicle-to-infrastructure/network (V2I), covering LTE-based communication between a vehicle and a roadside unit (RSU)/network. A RSU is a transportation infrastructure entity (e.g. an entity transmitting speed notifications) implemented in an eNodeB (eNB) or a stationary UE.

In V2X communication, a frequent handover is expected due to fast speed of vehicle UE. However, currently it is impossible for the UE to continue using a resource across cells during/after handover. This may lead to latency in data transfer. Accordingly, a method for using a common semi-persistent scheduling (SPS) resource across multiple cells for V2X communication may be required.

### DISCLOSURE OF INVENTION

### Technical Problem

The present invention provides a method and apparatus for allocating a common semi-persistent scheduling (SPS) resource across multiple cells in a wireless communication system. The present invention provides a method and apparatus for configuring a common SPS resource that can be used across at least one cell for a predefined time duration.

### Solution to Problem

In an aspect, a method for determining validity of a semi-persistent scheduling (SPS) resource across multiple cells, by a user equipment (UE), in a wireless communication system is provided. The method includes receiving a SPS resource configuration including time information related to validity of the SPS resource configuration from a network, and determining whether the SPS resource configuration is valid or not according to the time information.

In another aspect, a user equipment (UE) in a wireless communication system is provided. The UE includes a memory, a transceiver, and a processor, coupled to the memory and the transceiver, that controls the transceiver to receive a semi-persistent scheduling (SPS) resource configuration including time information related to validity of the SPS resource configuration from a network, and determines whether the SPS resource configuration is valid or not according to the time information.

### Advantageous Effects of Invention

A common SPS resource can be used continuously during/after handover so that latency does not occur due to handover, especially in case of V2X communication.

### BRIEF DESCRIPTION OF DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows a method for allocating a common SPS resources according to an embodiment of the present invention.

FIG. 7 shows another method for allocating a common SPS resources according to an embodiment of the present invention.

FIG. 8 shows a wireless communication system to implement an embodiment of the present invention.

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink LTE-advance (LTE-A) is an evolution of the 3GPP LTE.

For clarity, the following description will focus on the LTE-A. However, technical features of the present invention are not limited thereto.

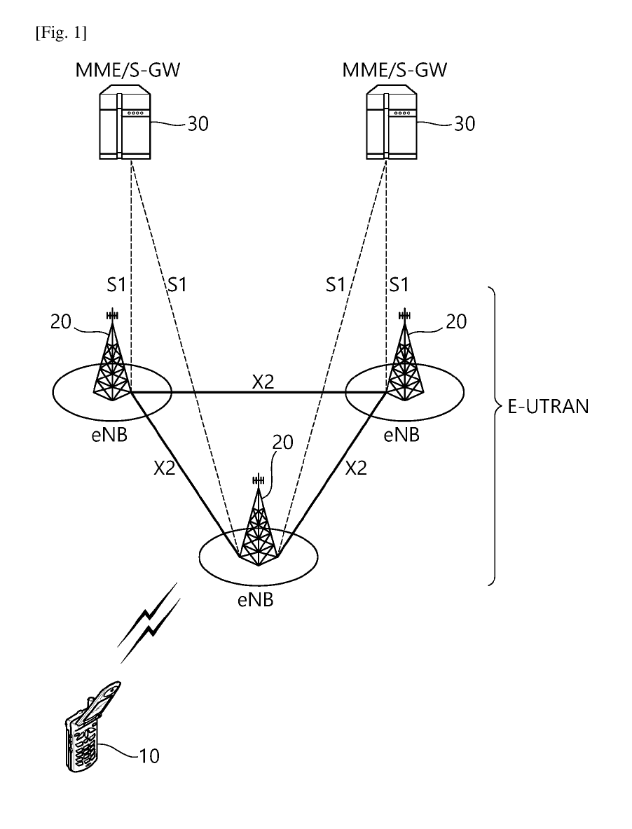

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

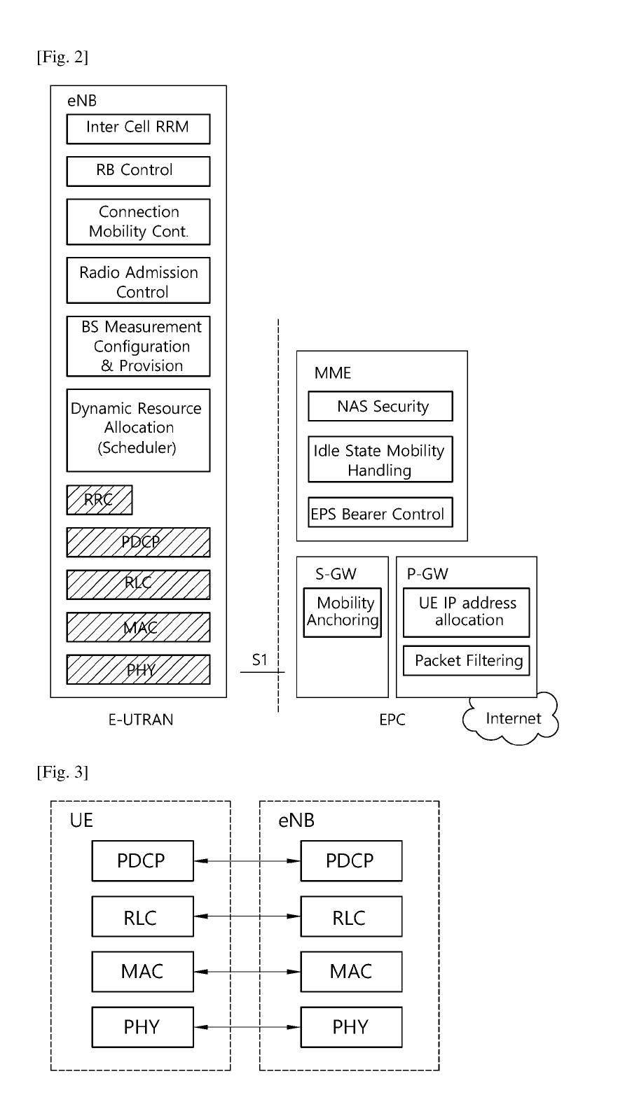

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

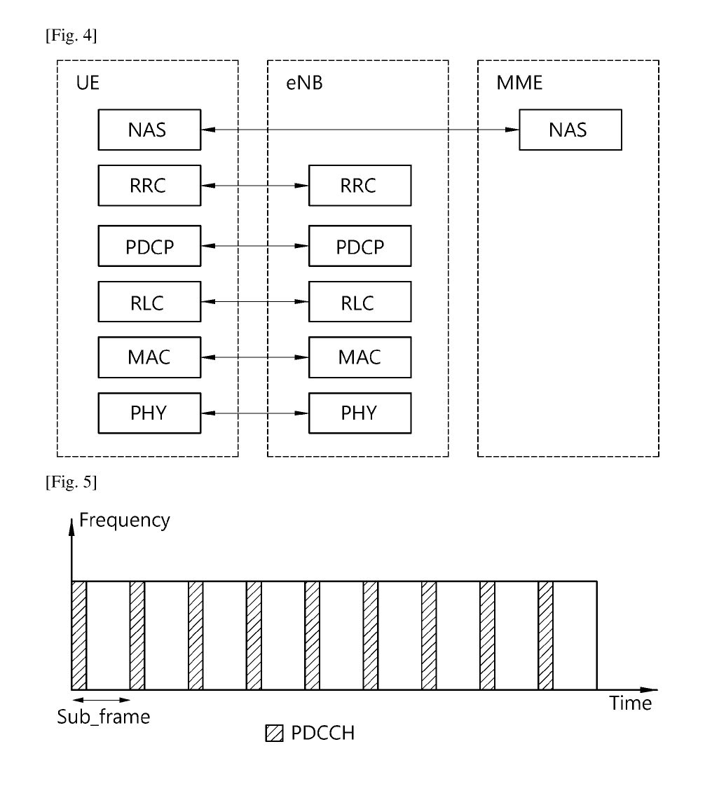

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or Ipv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARM). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, an uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

Semi-persistent scheduling (SPS) is described. E-UTRAN can allocate semi-persistent DL resources for the first HARQ transmissions to UEs. RRC defines the periodicity of the semi-persistent DL grant. PDCCH indicates whether the DL grant is a semi-persistent one, i.e. whether it can be implicitly reused in the following TTIs according to the periodicity defined by RRC.

When required, retransmissions are explicitly signaled via the PDCCH(s). In the subframes where the UE has semi-persistent DL resource, if the UE cannot find its cell radio network temporary identity (C-RNTI) on the PDCCH(s), a DL transmission according to the semi-persistent allocation that the UE has been assigned in the TTI is assumed. Otherwise, in the subframes where the UE has semi-persistent DL resource, if the UE finds its C-RNTI on the PDCCH(s), the PDCCH allocation overrides the semi-persistent allocation for that TTI and the UE does not decode the semi-persistent resources.

When carrier aggregation (CA) is configured, semi-persistent DL resources can only be configured for the primary cell (PCell) and only PDCCH allocations for the PCell can override the semi-persistent allocation. When dual connectivity (DC) is configured, semi-persistent DL resources can only be configured for the PCell or primary secondary cell (PSCell). Only PDCCH allocations for the PCell can override the semi-persistent allocation for PCell and only PDCCH allocations for the PSCell can override the semi-persistent allocation for PSCell.

In addition, E-UTRAN can allocate a semi-persistent UL resource for the first HARQ transmissions and potentially retransmissions to UEs. RRC defines the periodicity of the semi-persistent UL grant. PDCCH indicates whether the UL grant is a semi-persistent one, i.e. whether it can be implicitly reused in the following TTIs according to the periodicity defined by RRC.

In the subframes where the UE has semi-persistent UL resource, if the UE cannot find its C-RNTI on the PDCCH(s), a UL transmission according to the semi-persistent allocation that the UE has been assigned in the TTI can be made. The network performs decoding of the pre-defined PRBs according to the pre-defined MCS. Otherwise, in the subframes where the UE has semi-persistent UL resource, if the UE finds its C-RNTI on the PDCCH(s), the PDCCH allocation overrides the persistent allocation for that TTI and the UE's transmission follows the PDCCH allocation, not the semi-persistent allocation. Retransmissions are either implicitly allocated in which case the UE uses the semi-persistent UL allocation, or explicitly allocated via PDCCH(s) in which case the UE does not follow the semi-persistent allocation.

Similarly as for the DL, semi-persistent UL resources can only be configured for the PCell and only PDCCH allocations for the PCell can override the semi-persistent allocation. When DC is configured, semi-persistent UL resources can only be configured for the PCell or PSCell. Only PDCCH allocations for the PCell can override the semi-persistent allocation for PCell and only PDCCH allocations for the PSCell can override the semi-persistent allocation for PSCell.

When SPS is enabled by RRC, the following information is provided:
SPS C-RNTI;
UL SPS interval semiPersistSchedIntervalUL and number of empty transmissions before implicit release implicitReleaseAfter, if SPS is enabled for the UL;
Whether twoIntervalsConfig is enabled or disabled for UL, only for time division duplex (TDD);
DL SPS interval semiPersistSchedIntervalDL and number of configured HARQ processes for SPS numberOfConfSPS-Processes, if SPS is enabled for the DL;

When SPS for UL or DL is disabled by RRC, the corresponding configured grant or configured assignment shall be discarded.

The above information may be carried in SPS-Config information element (IE). The IE SPS-Config is used to specify the SPS configuration. Table 1 shows the SPS-Config IE.

TABLE 1
-- ASN1START

| | |
|---|---|
| SPS-Config ::= | SEQUENCE { |

| | | |
|---|---|---|
| semiPersistSchedC-RNTI | C-RNTI | OPTIONAL, -- Need OR |
| sps-ConfigDL | SPS-ConfigDL | OPTIONAL, -- Need ON |
| sps-ConfigUL | SPS-ConfigUL | OPTIONAL -- Need ON |

}

| | |
|---|---|
| SPS-ConfigDL ::= | CHOICE{ |
| release | NULL, |
| setup | SEQUENCE { |

| | |
|---|---|
| semiPersistSchedIntervalDL | ENUMERATED { |

```
  sf10, sf20, sf32, sf40, sf64, sf80,
  sf128, sf160, sf320, sf640, spare6,
  spare5, spare4, spare3, spare2,
  spare1},
```

| | |
|---|---|
| numherOfConfSPS-Processes | INTEGER (1..8), |
| n1PUCCH-AN-PersistentList | N1PUCCH-AN-PersistentList, |

| ..., | |
|---|---|
| [[ twoAntennaPortActivated-r10 | CHOICE { |

| | |
|---|---|
| release | NULL, |
| setup | SEQUENCE { |

| | |
|---|---|
| n1PUCCH-AN-PersistentListP1-r10 | N1PUCCH-AN-PersistentList |

}

| | |
|---|---|
| } | OPTIONAL -- Need ON |

]]

}
}

| | |
|---|---|
| SPS-ConfigUL ::= | CHOICE { |

| | |
|---|---|
| release | NULL, |
| setup | SEQUENCE { |

| | |
|---|---|
| semiPersistSchedIntervalUL | ENUMERATED { |

sf10, sf20, sf32, sf40, sf64, sf80,
sf128, sf160, sf320, sf640, spare6,
spare5, spare4, spare3, spare2,
spare1},

| | |
|---|---|
| implicitReleaseAfter | ENUMERATED {e2, e3, e4, e8}, |
| p0-Persistent | SEQUENCE { |

| | |
|---|---|
| p0-NominalPUSCH-Persistent | INTEGER (−126..24), |
| p0-UE-PUSCH-Persistent | INTEGER (−8..7) |

| } | | OPTIONAL, -- Need OP |
|---|---|---|
| twoIntervalsConfig | ENUMERATED {true} | OPTIONAL, -- Cond TDD |

| ..., | |
|---|---|
| [[ p0-PersistentSubframeSet2-r12 | CHOICE { |

| | |
|---|---|
| release | NULL, |
| setup | SEQUENCE { |

| | |
|---|---|
| p0-NominalPUSCH-PersistentSubframeSet2-r12 | INTEGER (−126..24), |
| p0-UE-PUSCH-PersistentSubframeSet2-r12 | INTEGER (−8..7) |

| } | |
|---|---|
| } | OPTIONAL -- Need ON |

]]

}
}

| | |
|---|---|
| N1PUCCH-AN-PersistentList ::= | SEQUENCE (SIZE (1..4)) OF INTEGER (0..2047) |

-- ASN1STOP

As described above, the SPS-Config IE may include at least one of SPS C-RNTI (semiPersistSchedC-RNTI), UL SPS interval (semiPersistSchedIntervalUL) and number of empty transmissions before implicit release (implicitReleaseAfter), whether twoIntervalsConfig is enabled or disabled for UL (twoIntervalsConfig), and DL SPS interval (semiPersistSchedIntervalDL) and number of configured HARQ processes for SPS (numberOfConfSPS-Processes), if SPS is enabled for the DL.

The SPS-Config IE may be included in RadioResourceConfigDedicated IE. The IE RadioResourceConfigDedicated is used to setup/modify/release RBs, to modify the MAC main configuration, to modify the SPS configuration and to modify dedicated physical configuration. The RadioResourceConfigDedicated IE may be included in one of RRCConnectionReconfiguration message, RRCConnectionReestablishment message, or RRCConnectionSetup message. Table 2 shows The RadioResourceCon-figDedicated IE.

TABLE 2
-- ASN1START
RadioResourceConfigDedicated ::= SEQUENCE {

| | | |
|---|---|---|
| srb-ToAddModList | SRB-ToAddModList | OPTIONAL, -- Cond HO-Conn |

| | | |
|---|---|---|
| drb-ToAddModList | DRB-ToAddModList | OPTIONAL, -- Cond HO-toEUTRA |

| | | |
|---|---|---|
| drb-ToReleaseList | DRB-ToReleaseList | OPTIONAL, -- Need ON |

| | |
|---|---|
| mac-MainConfig | CHOICE { |

| explicitValue | MAC-MainConfig, | |
|---|---|---|
| defaultValue | NULL | OPTIONAL, -- Cond HO-toEUTRA2 |

| | | |
|---|---|---|
| sps-Config | SPS-Config | OPTIONAL,-- Need ON |

| | | |
|---|---|---|
| physicalConfigDedicated | PhysicalConfigDedicated | OPTIONAL, -- Need ON |

| ..., | | |
|---|---|---|
| [[ rlf-TimersAndConstants-r9 | RLF-TimersAndConstants-r9 | OPTIONAL -- Need ON |
| ]], | | |
| [[ measSubframePatternPCell-r10 | MeasSubframePatternPCell-r10 | OPTIONAL -- Need ON |
| ┐┐, | | |
| [[ neighCellsCRS-Info-r11 | NeighCellsCRS-Info-r11 | OPTIONAL -- Need ON |
| ]], | | |
| [[ naics-Info-r12 | NAICS-AssistanceInfo-r12 | OPTIONAL -- Need ON |

┘┘}

RadioResourceConfigDedicatedPSCell-r12 ::= SEQUENCE {

| -- UE specific configuration extensions applicable for an PSCell | | |
|---|---|---|
| physicalConfigDedicatedPSCell-r12 | PhysicalConfigDedicated | OPTIONAL, -- Need ON |
| sps-Config-r12 | SPS-Config | OPTIONAL, -- Need ON |
| naics-Info-r12 | NAICS-AssistanceInfo-r12 | OPTIONAL, -- Need ON |

...

}

Referring to Table 2, the RadioResourceConfigDedicated IE may include The SPS-Config IE. Except for handover or releasing SPS for master cell group (MCG), E-UTRAN does not reconfigure SPS-Config for MCG when there is a configured DL assignment or a configured UL grant for MCG. Except for SCG change or releasing SPS for SCG, E-UTRAN does not reconfigure SPS-Config for SCG when there is a configured DL assignment or a configured UL grant for SCG.

Vehicle-to-everything (V2X) communication is described. V2X communication contains three different types, which are vehicle-to-vehicle (V2V) communications, vehicle-to-infrastructure (V2I) communications, and vehicle-to-pedestrian (V2P) communications. These three types of V2X can use “co-operative awareness” to provide more intelligent services for end-users. This means that transport entities, such as vehicles, roadside infrastructure, and pedestrians, can collect knowledge of their local environment (e.g. information received from other vehicles or sensor equipment in proximity) to process and share that knowledge in order to provide more intelligent services, such as cooperative collision warning or autonomous driving.

V2X service is a type of communication service that involves a transmitting or receiving UE using V2V application via 3GPP transport. Based on the other party involved in the communication, it can be further divided into V2V service, V2I service, V2P service, and vehicle-to-network (V2N) service. V2V service is a type of V2X service, where both parties of the communication are UEs using V2V application. V2I service is a type of V2X Service, where one party is a UE and the other party is a road side unit (RSU) both using V2I application. The RSU is an entity supporting V2I service that can transmit to, and receive from a UE using V2I application. RSU is implemented in an eNB or a stationary UE. V2P service is a type of V2X service, where both parties of the communication are UEs using V2P application. V2N service is a type of V2X Service, where one party is a UE and the other party is a serving entity, both using V2N applications and communicating with each other via LTE network entities.

For V2V, E-UTRAN allows such UEs that are in proximity of each other to exchange V2V-related information using E-UTRA(N) when permission, authorization and proximity criteria are fulfilled. The proximity criteria can be configured by the mobile network operator (MNO). However, UEs supporting V2V service can exchange such information when served by or not served by E-UTRAN which supports V2X Service. The UE supporting V2V applications transmits application layer information (e.g. about its location, dynamics, and attributes as part of the V2V service). The V2V payload must be flexible in order to accommodate different information contents, and the information can be transmitted periodically according to a configuration provided by the MNO. V2V is predominantly broadcast-based. V2V includes the exchange of V2V-related application information between distinct UEs directly and/or, due to the limited direct communication range of V2V, the exchange of V2V-related application information between distinct UEs via infrastructure supporting V2X service, e.g., RSU, application server, etc.

For V2I, the UE supporting V2I applications sends application layer information to RSU. RSU sends application layer information to a group of UEs or a UE supporting V2I applications. V2N is also introduced where one party is a UE and the other party is a serving entity, both supporting V2N applications and communicating with each other via LTE network.

For V2P, E-UTRAN allows such UEs that are in proximity of each other to exchange V2P-related information using E-UTRAN when permission, authorization and proximity criteria are fulfilled. The proximity criteria can be configured by the MNO. However, UEs supporting V2P service can exchange such information even when not served by E-UTRAN which supports V2X Service. The UE supporting V2P applications transmits application layer information. Such information can be broadcast by a vehicle with UE supporting V2X service (e.g., warning to pedestrian), and/or by a pedestrian with UE supporting V2X service (e.g., warning to vehicle). V2P includes the exchange of V2P-related application information between distinct UEs (one for vehicle and the other for pedestrian) directly and/or, due to the limited direct communication range of V2P, the exchange of V2P-related application information between distinct UEs via infrastructure supporting V2X service, e.g., RSU, application server, etc.

According to prior art, upon handover, RRC is reconfigured and SPS configuration is either released or reconfigured. More specifically, when the UE receives an RRC-ConnectionReconfiguration message including the mobilityControlInfo (i.e. handover), MCG MAC and SCG MAC is reset, if configured. If the received RRCConnectionReconfiguration message includes radioResourceConfigDedicated and the radioResourceConfigDedicated includes sps-Config, SPS reconfiguration is performed. The UE shall reconfigure the SPS in accordance with the received sps-Config. Further, MAC is reset and all time alignment timer (TAT) expires, hence, all configured SPS resources are released. More specifically, upon handover, when MAC is reset, all timeAlignmentTimers are considered as expired. When a timeAlignmentTimer expires, if the timeAlignmentTimer is associated with the primary timing advance group (pTAG), any configured DL assignments and UL grants are cleared.

As described above, upon handover, all configured SPS resources are release and SPS configuration is either release or reconfigured. Thus, it is impossible for the UE to continue using a SPS resource across multiple cells during/after handover. This may lead to latency in data transfer.

However, in V2X communication, it is important to reduce the latency so that delay-critical data, e.g. decentralized environmental notification message (DENM) or co-operative awareness message (CAM), is transferred in time. Given that V2X communication is a data communication including at least one vehicle UE (i.e. moving car), it may need to take handover into account when designing resource allocation scheme for V2X communication. In this sense, it may seem to be required to have a mechanism that enables continuing use of the resources during/after handover so that latency due to handover can be minimized. Further, SPS resource may be considered as resources for V2X communication.

In order to solve the problem described above, a method for allocating a common SPS resource across multiple cells (e.g. contiguous cells) can be proposed according to the present invention. According to an embodiment of the present invention, the UE may be configured with SPS resources that can be used across at least one cell for a pre-defined time duration. For this, the UE may receive a SPS resource configuration (SPS-Config) which includes the pre-defined time duration. Further, the SPS-Config may further include a list of the at least one cell in which the SPS resources can be used. While using the SPS resources according to the received SPS-Config, the UE may suspend or resume use of SPS resources upon a specific event while keeping the SPS-Config according to the received SPS-Config.

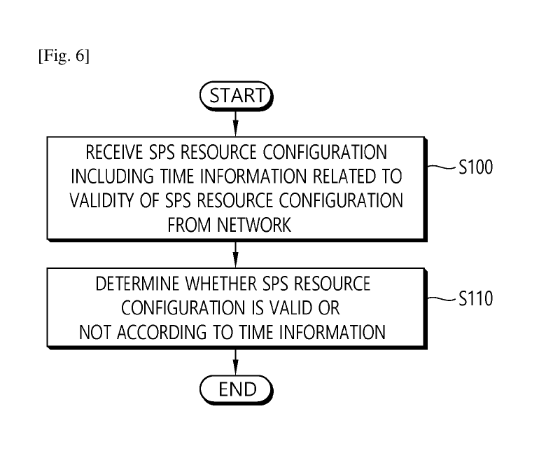

FIG. 6 shows a method for allocating a common SPS resources according to an embodiment of the present invention.

In step S100, the UE receives a SPS resource configuration from the network. The eNB may provide the SPS resource configuration (SPS-Config) to the UE by RRC signaling. The SPS-Config may include the following information.
Time/Frequency information of the SPS resources
Interval of the SPS resources
SPS C-RNTI
Time information related to validity of the SPS resource configuration.
List of at least one cell (SPSCellList)

Among the above information included in the SPS-Config, the time/Frequency information of the SPS resources, the interval of the SPS resources and the SPS C-RNTI are information currently included in the SPS-Config (refer to Table 1). However, according to an embodiment of the present invention, the SPS-Config may further include the time information related to validity of the SPS-Config and the list of at least one cell in which the SPS resources can be used.

In step S110, the UE determines whether the SPS resource configuration is valid or not. The UE may use the SPS resources according to the received SPS resource configuration (SPS-Config) only if the UE considers that the received SPS-Config as valid. In order to determine whether the SPS-Config is valid or not, the UE uses the time information related to validity of the SPS-Config and/or the list of at least one cell included in the SPS-Config.
The time information related to validity of the SPS-Config may be a validity duration (SPSValidDuration) during which the SPS-Config is valid. The validity duration may be a unit of subframes, radio frames, milliseconds, or seconds. That is, SPSValidDuration is a time period during which the UE considers that the received SPS-Config is valid. More specifically, after activating use of SPS resource according to the received SPS-Config, if SPSValidDuration has passed, the UE may consider that received SPS-Config is not valid any more even when the UE is on a serving cell which is included in the SPSCellList. Alternatively, the time information related to validity of the SPS-Config may be an end time which specifies until when the SPS-Config is valid.
The list of at least one cell (SPSCellList) is a list of at least one cell where the UE considers that the received SPS-Config is valid. More specifically, within SPSValid-Duration, if the UE is on a serving cell identified by the cell identifier which is included in the SPSCellList, the UE may consider that the SPSOconfig is valid. Within SPSValidDuration, if the UE is on a serving cell identified by the cell identifier which is not included in the SPSCellList, the UE may consider that the SPS-Config is not valid. In addition, if SPSValidDuration has passed, the UE may consider that the SPS-Config is not valid even when the UE is on a serving cell identified by the cell identifier which is included in the SPSCellList.

The detailed procedure for using SPS resources across at least one cell according to an embodiment of the present invention is as follows. The eNB may configure the SPS-Config to the UE. The SPS-Config may include the time information related to validity of the SPS-Config (e.g. SPSValidDuration) and/or the list of at least one cell included in the SPS-Config. The UE may activate use of SPS resources according to the SPS-Config by receiving an activation command, e.g. PDCCH addressed by SPS C-RNTI, from the eNB. After the UE activates use of the SPS resources, the UE may transmit and receives data on the SPS resources if data is available for transmission, while the UE considers the SPS-Config as valid. The data may only refer V2X data, e.g. DENM and/or CAM.

While the UE considers the SPS-Config as valid, the UE may continue transferring data on the SPS resources according to the SPS-Config in case of handover initiation, handover failure, or radio link failure (RLF). That is, while the UE considers the SPS-Config as valid, the UE may keep transmitting (periodical) V2X message, regardless of handover, handover failure or RLF, based on cell list until the eNB reconfigures SPS resources (and until a timer expires).

Alternatively, while the UE considers the SPS-Config as valid, the UE may suspend using the SPS resources while keeping the SPS-Config in case of handover initiation, handover failure, RLF, or reception of SPS suspension command from the eNB via L2 signaling. After suspending using SPS resources, the UE may resume using SPS resources according to the SPS-Config in case of handover completion (either handover failure or handover success), transmission of data from CCCH, scheduling request (SR), buffer status reporting (BSR), reception of SPS resumption command from the eNB via L2 signaling, or data transfer on a contention-based physical uplink shared channel (CB-PUSCH) resource, if configured. That is, SR or CB-PUSCH may be used to resume SPS configuration at a target cell. SR or CB-PUSCH may request the eNB to resume SPS configuration, e.g. by BSR.

Alternatively, while the UE considers the SPS-Config as valid, the UE may reconfigure SPS resource configuration by receiving a new SPS-Config from the eNB. A serving cell may reconfigure SPS resources for the next cell list.

SPS C-RNTI is used for scheduling on the SPS resources while the SPS-Config is valid. In other words, the UE may keep using the same SPS C-RNTI for scheduling on the SPS resources across different cell while the SPS-Config is valid.

In order to allocate the same SPS resources to be used across at least one cell, when the eNB provides the SPS-Config to the UE, the eNB may take the followings into account:
the SPS resources available in the at least one cell, which may not be the current serving cell but other cell, or
the UE mobility (speed), or
cell size.

When the UE considers that the SPS-Config is no longer valid, the UE may either release the SPS-Config by itself or keep the SPS-Config while not transfer data by using the SPS resources according to the SPS-Config.

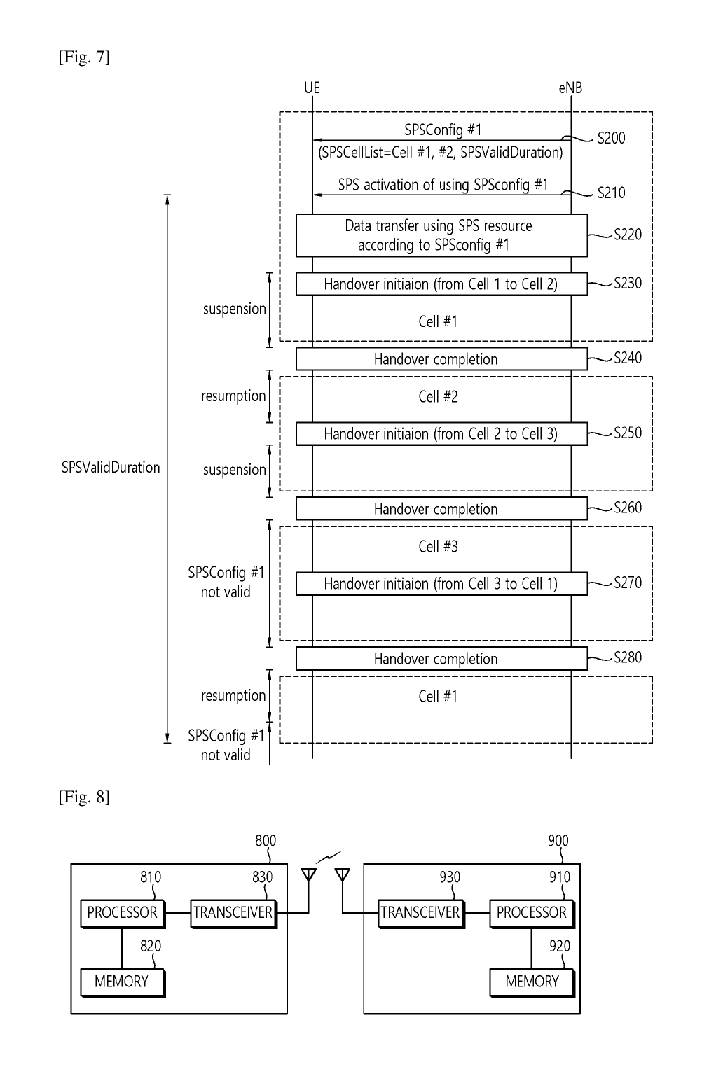

FIG. 7 shows another method for allocating a common SPS resources according to an embodiment of the present invention.

In step S200, the UE is on cell #1 and receives SPS-Config #1 from the eNB. The SPS-Config #1 includes time information related to validity of the SPS-Config #1 (in this embodiment, the time information is SPSValidDuration) and SPSCellList which includes cell #1 and cell #2.

In step S210, the UE activates use of the SPS resources according to the received SPS-Config #1 by receiving an activation command from the eNB. The UE starts to count SPSValidDuration upon activation of using the SPS resources according to the SPS-Config #1.

In step S220, the UE performs data transfer using the SPS resources according to the SPS-Config #1 on cell #1.

In step S230, the UE initiates handover from cell #1 to cell #2. Accordingly, the UE suspends using SPS resources according to SPS-Config #1.

In step S240, after completion of handover to cell #2, the UE resumes using the SPS resource according to SPS-Config #1, since cell #2 is included in the SPSCellList and SPSValidDuration has not passed yet.

In step S250, the UE initiates handover from cell #2 to cell #3. Accordingly, the UE suspends using SPS resources according to SPS-Config #1.

In step S260, after completion of handover to cell #3, even though SPSValidDuration has not passed yet, the UE considers that SPS-Config #1 is not valid because cell #3 is not included in the SPSCellList. Accordingly, the UE does not use the SPS resource according to SPS-Config #1. However, the UE may keep the SPS-Config #1.

In step S270, the UE initiates handover from cell #3 to cell #1.

In step S280, after completion of handover to cell #1, the UE resumes using the SPS resource according to SPS-Config #1, since cell #1 is included in the SPSCellList and SPSValidDuration has not passed yet. However, when SPSValidDuration has passed, the UE considers the SPS-Config #1 not valid anymore and stops using the SPS resources according to the SPS-Config #1 even though cell #1 is included in the SPS-CellList.

FIG. 8 shows a wireless communication system to implement an embodiment of the present invention.

An eNB 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1.A method for determining validity of a semi-persistent scheduling (SPS) resource across multiple cells, by a user equipment (UE), in a wireless communication system, the method comprising:
receiving a SPS resource configuration including time information related to validity of the SPS resource configuration from a network; and
determining whether the SPS resource configuration is valid or not according to the time information.

2. The method of claim 1, wherein the time information is a validity duration which indicates a time period during which the SPS resource configuration is valid.

3. The method of claim 2, wherein the validity duration is a unit of one of subframes, radio frames, milliseconds, or seconds.

4. The method of claim 1, wherein the time information is an end time which specifies until when the SPS resource configuration is valid.

5. The method of claim 1, wherein the SPS resource configuration further includes a SPS cell list which indicates a list of at least one cell where the SPS resource configuration is valid.

6. The method of claim 5, wherein whether the SPS resource configuration is valid or not is determined according the time information and the SPS cell list.

7. The method of claim 6, wherein the SPS resource configuration is determined to be valid in a cell when the cell is included in the SPS cell list within the time information.

8. The method of claim 1, when the SPS resource configuration is determined to be valid, further comprising continuing transferring data by using SPS resources according to the SPS resource configuration.

9. The method of claim 1, when the data is vehicle-to-everything (V2X) data.

10. The method of claim 1, when the V2X data is one of a decentralized environmental notification message (DENM) or a cooperative awareness message (CAM).

11. The method of claim 1, when the SPS resource configuration is determined to be valid, further comprising suspending using SPS resources while keeping the SPS resource configuration.

12. The method of claim 11, further comprising resuming using the SPS resources according to the SPS resource configuration.

13. The method of claim 1, when the SPS resource configuration is determined to be valid, further comprising reconfiguring the SPS resource configuration.

14. A user equipment (UE) in a wireless communication system, the UE comprising:
a memory;
a transceiver; and
a processor, coupled to the memory and the transceiver, that:
controls the transceiver to receive a semi-persistent scheduling (SPS) resource configuration including time information related to validity of the SPS resource configuration from a network, and
determines whether the SPS resource configuration is valid or not according to the time information.
